(19) United States
(12) Patent Application Publication
(10) Pub. No.: US 2002/0181611 A1
(43) Pub. Date: Dec. 5, 2002

(54) Analog quadrature modulator (AQM) error compensating apparatus and method

(75) Inventor: Wang Rae Kim, Anyang (KR)

Correspondence Address: FLESHNER & KIM, LLP, P.O. Box 221200, Chantilly, VA, 20153-1200, US

(73) Assignee: LG Electronics Inc.

(21) Appl. No.: 10/157,929

(22) Filed: May 31, 2002

(30) Foreign Application Priority Data
Jun. 1, 2001 (KR) 30855/2001
Dec. 24, 2001 (KR) 84320/2001

(51) Int. Cl. H04K 1/02

(52) U.S. Cl. 375/296; 375/298

(57) ABSTRACT

An AQM error compensating apparatus includes: a predistorter for distorting a signal so as to have the opposite characteristics of nonlinear distortion characteristics of a digital input signal; an error compensating unit for compensating I/Q digital signals outputted from the predistorter according to an error correction signal; a digital/analog converter for converting the I/Q digital signals of the error compensating unit into I/Q analog signals; a modulator for frequency-modulating the I/Q analog signals outputted from the digital/analog converter; a power amplifier for amplifying the output signal of the modulator to a directional coupler; a down-converter for down-converting a feedback signal inputted from the directional coupler; an analog/digital converter for converting the output signal of the down-converter into a digital signal; and a controller for comparing the output signal of the analog/digital converter with the I/Q digital signals inputted from the predistorter, and applying an extracted error correction signal into the error compensating unit. An AQM error can be compensated by extracting the DC offset and gain and the correction value for the phase error by using a sine wave for an initial certain time of a system, and even while a signal is being transmitted after being varied, the AQM error also can be compensated by comparing an inputted reference signal and a feedback signal and extracting a correction value for each error. Thus, the error can be accurately compensated according to its occurrence.

### BACKGROUND OF THE INVENTION

1. Field of the Invention

The present invention relates to an analog quadrature modulator (AQM) error compensating apparatus and method, and more particularly, to an AQM error compensating apparatus and method for removing an AQM error according nonlinear characteristics and a thermal noise of a detector.

2. Description of the Background Art

In general, a power amplifier amplifies an inputted radio frequency signal, and in this respect, ideally, the power amplifier would amplify only the strength of the signal only linearly without distortion of the input signal.

However, since every power amplifier includes a plurality of active devices with nonlinear characteristics, the overall system including the power amplifier is negatively influenced in its performance.

As methods for improving the nonlinear characteristics of the power amplifier, there are a feed forward method, an envelope feedback method, a predistortion method, a bias compensation method, and the like.

Recently, among the linearization methods, the predistortion method is widely used as its price is the lowest for its performance and it operates in a wider band width.

The predistortion method improves a linearity of a system in such a manner than an input signal is predistorted to have the opposite characteristics to nonlinear distortion characteristics and inputted to a power amplifier. Since the predistortion method can be implemented in a baseband, the size and efficiency of the overall system can be enhanced.

In addition, in order to implement a predistortion system having a wider bandwidth, an AQM, not a digital quadrature modulation (DQM) is used to implement an overall system.

However, since the AQM includes an analog device, it has an error component such as a DC offset or an amplitude/phase imbalance, which serves as a main factor to degrade the performance of a predistortor. Thus, in order to obtain an optimum performance of the predistorter, the AQM error should be compensated.

FIG. 1 is a block diagram illustrating an analog quadrature modulator (AQM) error compensating apparatus.

As shown in FIG. 1, a path from a predistorter 110 to a directional coupler 5 is the main path, while a path from the directional coupler 5 to a controller 9 is a feedback path to detect an error component mostly generated from the AQM. At this time, an error component is generated in the AQM due to a DC offset, a gain and a phase imbalance.

The conventional analog quadrature modulator error compensating apparatus includes: a predistorter 110 for pre-distorting a digital signal inputted through a modem 1 against nonlinear characteristics; an error compensating unit 120 for compensating the digital signal outputted from the predistorter 110 according to an error correction signal; a digital-to-analog converter 10 for converting the digital signal outputted from the error compensating unit 120 into an analog signal; a modulator 20 for modulating the analog signal outputted from the digital-to-analog converter 10 to a frequency of carrier; a power amplifier for amplifying the output signal of the modulator 20 and supplying it to a directional coupler 5; am amplifier 6 for amplifying a feedback signal inputted from the directional coupler 5, to a certain level; a detector 7 for measuring a DC average value of a signal outputted from the amplifier 6; an analog-to-digital converter 8 for converting the DC average value outputted from the detector 7 into a digital signal; and a controller 9 for sensing an error through the output signal of the analog-to-digital converter 8 and outputting an error correction signal to compensate the error.

The error compensating unit 120 implements an equivalent circuit of the modulator 20, and the predistorter 110 distorts the digital input signal to have the opposite characteristics of the nonlinear distortion characteristics of the power amplifier 4, and separates the digital input signal into I/Q digital signals (Id, Qd) to output them.

The error compensating unit 120 includes: a first amplifier 121 for controlling a gain of the I-digital signal (Id) predistorted according to a first gain correction signal (α) transmitted from the controller 9; a second amplifier 122 for controlling a gain of the Q-digital signal (Qd) predistorted according to a second gain correction signal (β) transmitted from the controller 9; a third amplifier 122 for controlling a phase of an output signal of the second amplifier 122 according to a first phase correction signal (sinφ); a fourth amplifier 125 for controlling a phase of an output signal of the second amplifier 122 according to a second phase correction signal (cosφ); a first adder 124 for adding outputs of the first amplifier 121 and the third amplifier 123; a second adder 126 for adding the output signal of the first adder 124 and a first DC offset signal (C1); and a third adder 127 for adding an output signal of the fourth amplifier 125 and a second DC offset signal (C2).

The digital-to-analog converter 10 includes a first digital/analog converter 11 for receiving the I-digital signal outputted from the error compensating unit 120 and converting it into an I-analog signal; and a second digital/analog converter 12 for receiving the Q-digital signal outputted from the error compensating unit 120 and converting it into a Q-analog signal.

The modulator 20 includes: a first multiplier 21 for multiplying the I-analog signal outputted from the first digital/analog converter 11 and a local oscillation frequency signal outputted from a local oscillator (L.O); a second multiplier 22 for multiplying the Q-analog signal outputted from the second digital/analog converter 12 and a local oscillation frequency signal outputted from the local oscillator (L.O); and a synthesizer 23 for synthesizing the output signals of the first and second multipliers 21 and 22 and outputting a radio frequency signal.

The operation of the conventional AQM error compensating apparatus constructed as described above will now be explained.

First, the predistorter 110 distorts a digital signal inputted through the modem 1 to have the opposite characteristics of the nonlinear distortion characteristics of the power amplifier 4 and outputs an I-digital signal (Id) and a Q-digital signal (Qd).

The error compensating unit 120 corrects an error of the I/Q digital signals (Id, Qd) outputted from the predistorter 110, applies them to the first and second digital/analog converters 11 and 12.

Then, the first and second digital/analog converters 11 and 12 convert the inputted I/Q digital signals into I/Q analog signals and output them.

That is, the first digital/analog converter 11 receives the I-digital signal and converts it into an I-analog signal, while the second digital/analog converter 12 receives the Q-digital signal and converts it into the Q-analog signal.

The modulator 20 receives the I/Q analog signals outputted from the first and second digital/analog converters 11 and 12 and AQM-modulates them.

That is, in the modulator 20, the first multiplier 21 multiplies the I-analog signal outputted from the first digital/analog converter 11 and the local oscillation frequency signal outputted from the local oscillator, for up-converting, and the second multiplier 22 multiplies the Q-analog signal outputted from the second digital/analog converter 12 and a signal having a 90 degree phase imbalance for a local oscillation frequency, for up-converting.

Each of the up-converted signals is synthesized to a radio frequency signal by the synthesizer 23 and applied to the power amplifier 4.

The amplifier 6 amplifies a feedback signal inputted from the directional coupler 5 through the power amplifier 4, to a certain level, and the detector 7 measure a DC average value of the signal outputted from the amplifier 6 and outputs it to the analog/digital converter 8.

The analog/digital converter 8 converts the DC average value outputted from the detector 7 into a digital signal and applies it to the controller 9, and the controller 9 measures an error through the converted and outputted signal and applies an error correction signal for compensating the error value into the error compensating unit 120.

At this time, the error correction signals includes a first and second DC offset signals (C1, C2) for correcting the DC offset of the I/Q digital signals; a first and second gain correction signals (α and β) for correcting a gain error of the I/Q digital signal; and a phase correction signal (φ) for correcting a phase error of the I/Q digital signal.

The process for determining the error correction signal will now be described in detail with reference to FIGS. 2, 3 and 4.

FIG. 2 is a drawing illustrating a process for determining first and second DC offset signals for the DC offset.

As shown in FIG. 2, the controller 9 sets a test vector as ‘0’ and initializes a gain imbalance, a phase imbalance and a DC offset imbalance value of the error correction apparatus (step S11), fixes the DC offset signal (C2) of the Q channel, and varies the DC offset signal (C1) of the I-channel (step S12).

At this time, the controller 9 detects a signal outputted to the detector 7 and determines a time point where the output signal is minimal as the first DC offset signal (C1), the I-channel DC offset signal (steps S13, S14).

Referring to the second DC offset signal (C20, after the second DC offset signal (C2) fixes the DC offset signal (C1) of the I-channel; the DC offset signal (C2) of the Q channel is varied (step S15) to detect a signal outputted to the detector 7 and determine a time point where the output signal is minimal as the Q channel DC offset signal (C2) (step S17).

FIG. 3 is a drawing illustrating a process for determining a gain correction signal.

As shown in FIG. 3, the controller 9 applies a test vector with an I-channel signal of ‘A’ and a Q channel signal of ‘0’ (step S21) to detect a first output signal outputted from the detector 7 (step S22), and applies a test vector with an I-channel signal of ‘0’ and a Q-channel signal of a certain value ‘A’ (step S23) to detect a second output signal outputted from the detector 7 (step S24), and then, the controller determines whether a value obtained by dividing the first output signal by the second output signal is approximately ‘1’ (step S25).

If the value obtained by dividing the first output signal by the second output signal is greater than ‘1’, not approximately ‘1’ (step S26), the controller 9 fixes the second gain correction signal (β) as ‘1’ and then varies the first gain correction signal (α) to a value smaller than ‘1’.

If, however, the value obtained by dividing the first output signal by the second output signal is smaller than ‘1’, the controller 9 fixes the first gain correction signal (α) as ‘1’ and then varies the second gain correction signal (β) to a value smaller than ‘1’ (step S28), thereby determining the first and second gain correction signals (α and β) (step S29).

FIG. 4 is a drawing illustrating a process for determining a phase correction signal.

As shown in FIG. 4, when the controller 9 applies a certain test vector (A, A) to the I-channel and Q-channel (step S31) to detect a first output signal from the detector 7 (step S32), and applies a certain test vector (−A, A) to the I-channel and Q-channel (step S33) to detect a second output signal from the detector 7 (step S34), and determines the size of the first and second output signals to obtain a size ratio (Er) (step S35).

As for the size ratio (Er), if the first output signal is greater than the second output signal, it is determined that there is a difference smaller than 90 degree between the I and Q signals and a value obtained by dividing the first output signal by the second output signal is detected as the size ratio (Er) (step S36).

If, however, the first output signal is smaller than the second output signal, it is determined that there is a difference greater than 90 degree between the I and Q signals and a value obtained by dividing the second output signal by the first output signal is detected as the size ratio (Er) (step S37).

$$φ = 2 {tan ( \frac{{E}_{r} - 1}{{E}_{r} + 1} )}^{- 1} \qquad ( 1 )$$

The size ratio for the first and second output signals is substituted for equation (1) to calculate it (step S38), thereby detecting the phase correction signal (φ), by which the first phase correction signal (sinφ) and the second phase correction signal (cosφ) (step S39).

As stated above, in the conventional AQM error correcting apparatus, in order to extract an AQM error, the controller applies a test vector, an AQM error compensation value is calculated through the error due to the obtained DC offset, gain and a phase imbalance by the phase imbalance, and sets an error correction signal corresponding to the error compensation value, in advance.

Thus, the conventional AQM error correcting apparatus has the following problems.

That is, since the error correction signal previously set in the error compensating unit can not be adjusted even if an error generated from an input signal is varied, an error compensation is not accurately made.

In addition, due to the nonlinear characteristics and a thermal noise of the detector used to measure an AQM error, a calculation error may occur, and especially, there is a measurement limitation in measuring a DC offset that greatly affects a performance of a transmitter due to an operation area and a thermal noise of the detector.

The above references are incorporated by reference herein where appropriate for appropriate teachings of additional or alternative details, features and/or technical background.

### SUMMARY OF THE INVENTION

Therefore, an object of the present invention is to provide an AQM error compensating apparatus and method that are capable of varying an error correction signal according to an error generated from an input signal.

Another object of the present invention is to provide an AQM error compensating apparatus and method that are capable of removing a calculation error of an AQM error due to nonlinear characteristics and a thermal noise of a detector by extracting a data used for measuring an AQM error in a digital method.

To achieve at least the above objects in whole or in parts, there is provided an AQM error compensating apparatus in which after a DC offset and gain, and a phase error are detected by using a reference signal inputted directly to a predistorter from an input terminal and a feedback signal inputted from a directional coupler through a main path, an error correction signal for compensating a corresponding error is outputted.

To achieve at least these advantages in whole or in parts, there is further provided an AQM error compensating apparatus including: a predistorter for distorting a digital input signal so as to have the opposite characteristics of nonlinear distortion characteristics; an error compensating unit for compensating I/Q digital signals outputted from the predistorter according to an error correction signal; a digital/analog converter for converting the I/Q digital signals of the error compensating unit into I/Q analog signals; a modulator for frequency-modulating the I/Q analog signals outputted from the digital/analog converter; a power amplifier for amplifying the output signal of the modulator and providing a directional coupler with the amplified output signal; a down-converter for down-converting a feedback signal inputted from the directional coupler; an analog/digital converter for converting the output signal of the down-converter into a digital signal; and a controller for comparing the output signal of the analog/digital converter with the I/Q digital signals inputted from the predistorter, and applying an extracted error correction signal into the error compensating unit.

To achieve at least these advantages in whole or in parts, there is further provided an AQM error compensating method in which after an error is detected by using a reference signal inputted directly to a predistorter from an input terminal and a feedback signal inputted from a directional coupler through a main path, an error correction signal for compensating a corresponding error is outputted.

To achieve at least these advantages in whole or in parts, there is further provided an AQM error compensating method including the steps of: removing a DC offset of feedback signals; compensating a gain of the I/Q digital signals with no DC offset; compensating a time delay of the gain-compensated I/Q digital signals; and compensating a phase of the time delay-compensated I/Q digital signals.

To achieve at least these advantages in whole or in parts, there is further provided an AQM error compensating method including the steps of: interpolating I/Q digital signals inputted from a predistorter and feedback signals; compensating a gain by corresponding the sizes of two interpolated signals; repeatedly performing an operation that a time difference between the two size-corresponded signals is calculated while varying a constant value for an over-sampling ratio; and calculating a constant value that a time difference is minimal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing the construction of an AQM error compensating apparatus in accordance with a conventional art;

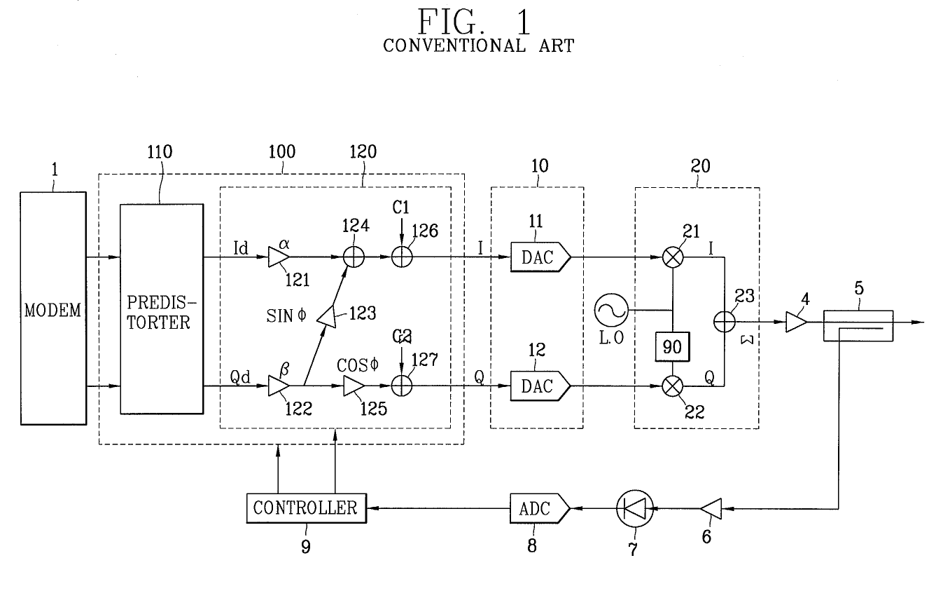

FIG. 2 is a flow chart of a process for detecting a DC offset signal in accordance with the conventional art;

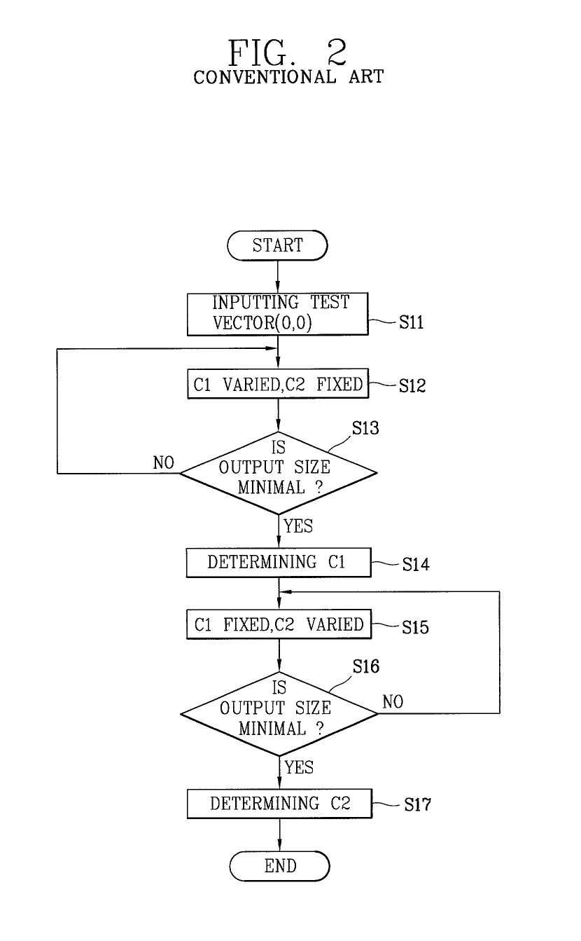

FIG. 3 is a flow chart of a process for detecting a gain correction signal in accordance with the conventional art;

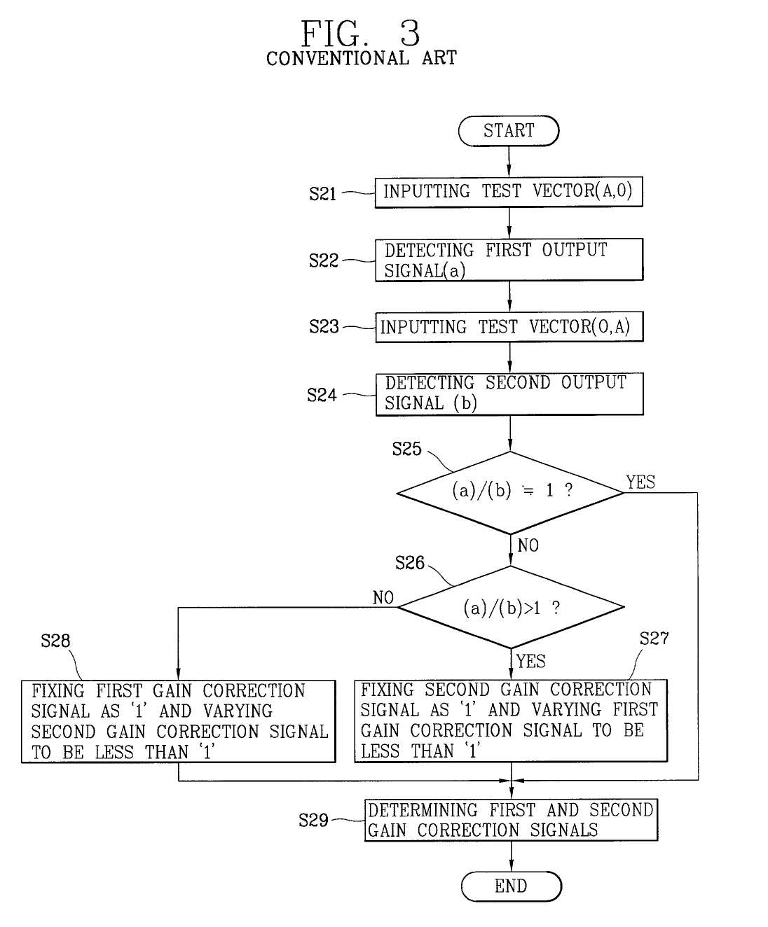

FIG. 4 is a flow chart of a process for detecting a phase correction signal in accordance with the conventional art;

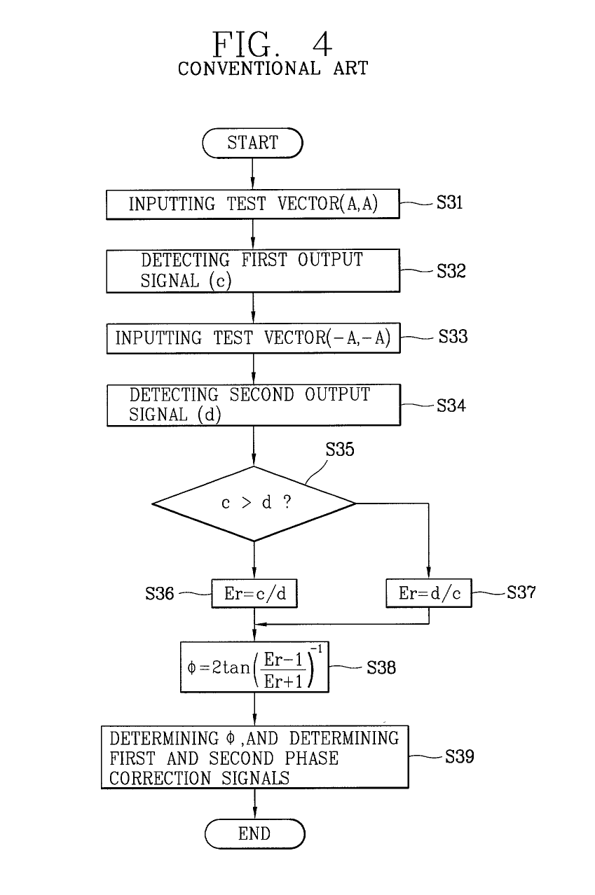

FIG. 5 is a block diagram showing the construction of an AQM error compensating apparatus in accordance with the present invention;

FIG. 6 is a flow chart of an AQM error compensating method in accordance with the present invention;

FIG. 7 is a flow chart of a process for detecting a DC offset signal in accordance with the present invention;

FIG. 8 is a flow chart of a process for detecting a gain correction signal in accordance with the present invention;

FIG. 9 is a flow chart of a time delay compensation in accordance with the present invention;

FIG. 10 is a flow chart of a process for detecting a phase correction signal in accordance with the present invention;

FIGS. 11A through 11C show waveforms after performing a time delay and an AQM compensation; and

FIGS. 12A and 12B show I/Q digital signals before and after AQM error compensation.

### DETAILED DESCRIPTION OF THE PREFERRED EMBODIMENTS

A preferred embodiment of an analog quadrature modulator (AQM) error compensating apparatus and method of the present invention will now be described with reference to the accompanying drawings.

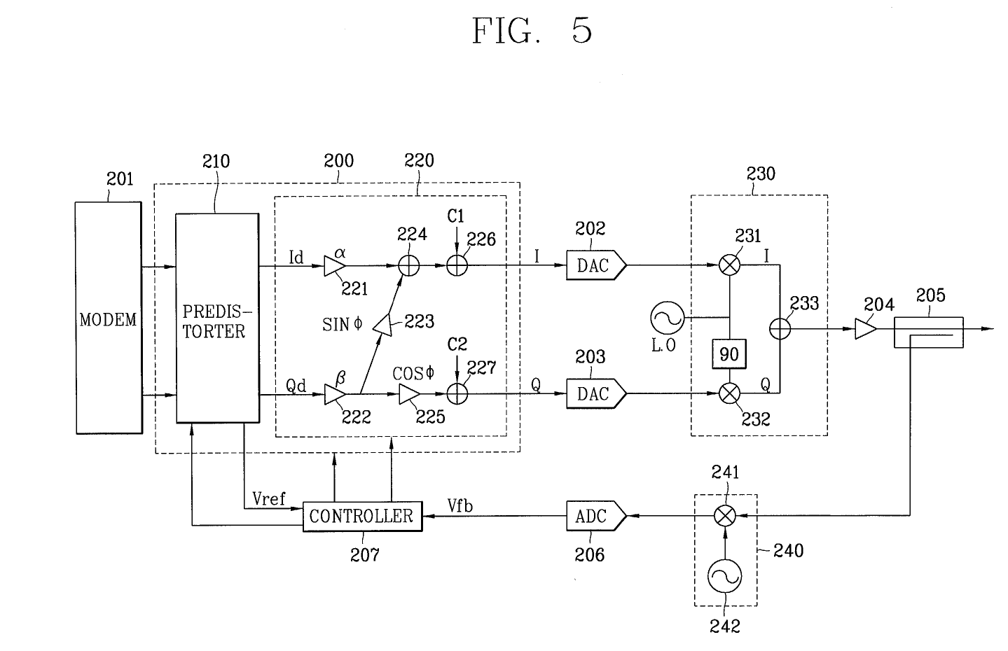

FIG. 5 is a block diagram showing the construction of an AQM error compensating apparatus in accordance with the present invention.

As shown in FIG. 5, an AQM error compensating apparatus of the present invention includes: a predistorter 210 for distorting a digital input signal so as to have the opposite characteristics of nonlinear distortion characteristics; an error compensating unit 220 for compensating I/Q digital signals (Id, Qd) outputted from the predistorter 210 according to an error correction signal in advance; first and second digital/analog converters 202 and 203 for converting the I/Q digital signals of the error compensating unit 220 into I/Q analog signals; modulator 230 for modulating the analog signals outputted from the first and second digital/analog converters 202 and 203 into a frequency of carrier; a power amplifier 204 for amplifying an output signal of the modulator 230 and supplying it to a directional coupler 205; a down-converter 240 for down-converting a feedback signal inputted from the directional coupler 205; an analog/digital converter 206 for converting an output signal of the down-converter 240 into a digital signal; and a controller 207 for comparing the output signal (Vfb) of the analog/digital converter 206 and the I/Q digital signal (Vref) inputted from the predistorter 210, extracting an error correction value, and applying a corresponding error correction signal to the error compensating unit 220.

The controller 207 controls the predistorter 210, applies a test signal for extracting an AQM error to a system, and calculates an AQM error compensation value through the extracted AQM error to output an error correction signal to the error compensating unit 220.

A signal that the controller 207 controls the predistorter 210 and a reference signal (Vref) inputted from the predistorter 210 to calculate the AQM error are exchanged between the controller 207 and the predistorter 210.

Accordingly, the controller 207 compares the feedback signal inputted from the directional coupler 205 and the reference signal (Vref) inputted from the predistorter 210 to extract an error and outputs an error correction signal for compensating each error.

The error compensating unit 220 includes: a first amplifier 221 for controlling a gain of the I-digital signal (Id) predistorted according to a first gain correction signal (α); a second amplifier 222 for controlling a gain of a Q-digital signal (Qd) predistorted according to a second gain correction signal (β) transmitted from the controller 207; a third amplifier 223 for controlling a phase of an output signal of the second amplifier 222 according to a first phase correction signal (sinφ); a fourth amplifier 225 for controlling a phase of an output signal of the second amplifier 222 according to the second phase correction signal (cosφ); a first adder 224 for adding output signals of the first amplifier 221 and the third amplifier 223; a second adder 226 for adding an output signal of the first adder 224 and a first DC offset signal (C1); and a third adder 227 for adding an output signal of the fourth amplifier 225 and a second DC offset signal (C2).

The modulator 230 includes: a first multiplier 231 for multiplying an I-analog signal outputted from the first digital/analog converter 202 and a local oscillation frequency signal outputted from a local oscillator (L.O); a second multiplier 232 for multiplying a Q-analog signal outputted from the second digital/analog converter 203 and a local oscillation frequency signal outputted from the local oscillator (L.O); and a synthesizer 233 for synthesizing output signals of the first and second multipliers 231 and 232 and outputting a radio frequency signal.

The operation of the AQM error compensating apparatus constructed as described above will now be explained.

First, the predistorter 210 controls a digital signal inputted through the modem 201, distorts the I/Q digital signals (Id, Qd) so as to have the opposite characteristics of the nonlinear distortion characteristics of the power amplifier 204 and inputs them to the error compensating unit 220.

The error compensating unit 220 corrects an error of the I/Q digital signals (Id, Qd) outputted from the predistorter 210 and applies them to the first and second digital/analog converters 202 and 203, and the first and second digital/analog converters 202 and 203 convert the inputted I/Q digital signals into I/Q analog signals and output them.

The modulator 230 receives the I/Q analog signals outputted from the first and second digital/analog converters 202 and 203 and AQM-modulates them.

That is, the first multiplier 231 of the modulator 230 multiplies the I-analog signal outputted from the first digital/analog converter 202 and the local oscillation frequency signal outputted from the local oscillator (L.O), and the second multiplier 232 multiplies the Q-analog signal outputted from the second digital/analog converter 203 and a signal having a 90 degree phase difference for a local oscillation frequency.

Each of the up-converted signals is synthesized to radio frequency signals by the synthesizer 233 and applied to the power amplifier 204.

The down-converter 240 down-converts the frequency of the feedback signal inputted from the directional coupler 205 after passing the power amplifier 204 and applies it to the analog/digital converter 206, and the analog/digital converter 206 converts the output signal of the down-converter 240 into a digital signal (Vfb) and outputs the digital signal to the controller 207.

The controller 207 performs a certain operation on the I/Q digital signals (Vref) inputted from the predistorter 210 and the I/Q digital signals received from the analog/digital converter 206 to extract an error value, and applies an error correction signal for correcting the error value to the error compensating unit 220.

Then, the error compensating unit 220 compensates the error of the I/Q digital signal according to the error correction signal,

At this time, the error correction signals includes: a first and second DC offset signals C1 and C2 for correcting a DC offset of the I/Q digital signals; a first and second gain correction signals (α and β) for correcting a gain error of the I/Q digital signals; and a phase correction signal (φ) for correcting a phase error of the I/Q digital signals.

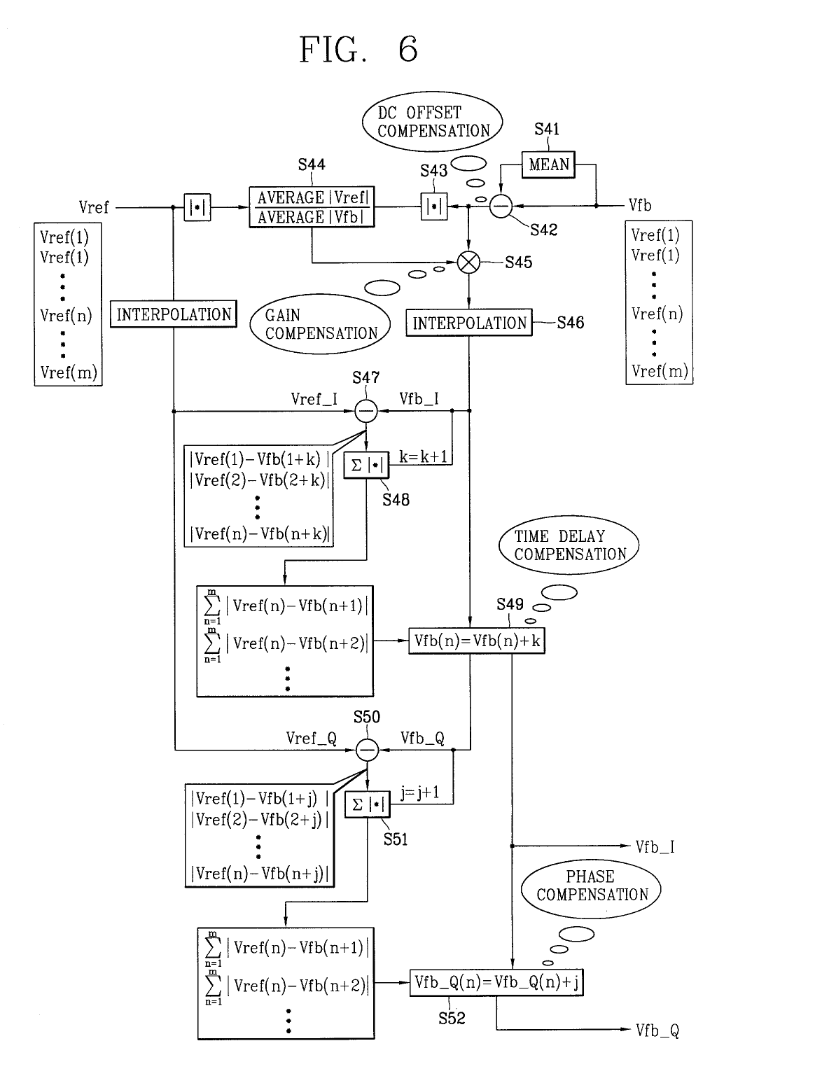

FIG. 6 is a flow chart of an AQM error compensating method in accordance with the present invention.

An AQM error compensating method of the present invention roughly includes: a process in which each DC offset from the feedback I/Q digital signals is detected and the DC offset of the feedback I/Q digital signals is removed (steps S41, S42); a process in which the reference signals inputted through the predistorter are compared to detect a gain correction value, and a gain of the I/Q digital signals without the DC offset is compensated (steps S43, S44, S45); a process in which after a time delay value is detected by using the reference signal inputted through the predistorter, the time delay of the I/Q digital signals is compensated (steps S46, S47, S48 and S49), and a process in which, after a phase correction value is detected by using the time delay-compensated Q-digital signal and the reference signal inputted through the predistorter, the time delay-compensated Q-digital signal is shifted according to the phase correction value (steps S50, S51 and S52).

The AQM error compensating method of the present invention will now be described in detail with reference to FIGS. 6, 7, 8, 9 and 10.

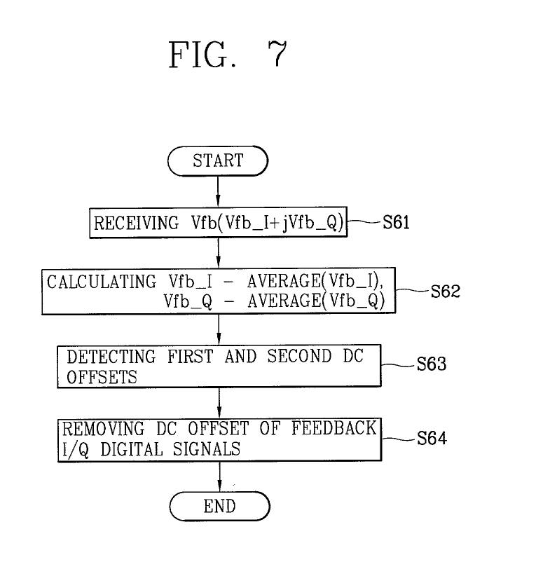

Referring to the process for removing the DC offset as shown in FIG. 7, the controller 207 extracts each average value for certain number of the I/Q digital signals (Vfb:Vfb_I+jVfb_Q) inputted through the analog/digital converter 206 (step S61), and subtracts each average value from the feedback I/Q digital signals (Vfb) (step S62).

The controller 207 detects the difference value according to the subtraction as the first and second DC offset (C1 and C2) (step S63) and applies it to the error compensating unit, so as to remove the DC offset of the feedback I/Q digital signals (Vfb)(step S64).

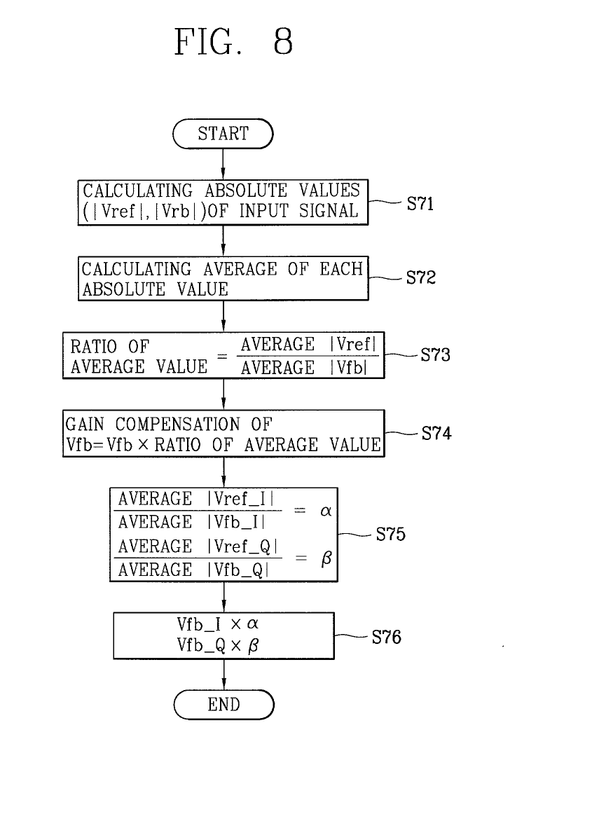

Referring to the processing for compensating a gain of the feedback I/Q digital signals (Vfb) as shown in FIG. 8, the controller 207 extracts absolute values of the reference I/Q digital signals (Vref) inputted from the predistorter 201 and the feedback I/Q digital signals (Vref) (step S71) and calculates each average value for the absolute value of the reference I/Q digital signals (|Vref|) and the absolute value (|Vfb|) of the feedback I/Q digital signals (step S72).

The ratio of the average value of the reference I/Q digital signals (Vref0 to the feedback I/Q digital signals (Vfb) is multiplied by the feedback I/Q digital signals (Vref), thereby compensating the gain (steps S73 and S74).

The ratio of the average of the absolute value of the gain-compensated I-digital signal to the average of the absolute value of the feedback I-digital signal is detected as the first gain correction signal (α) and a ratio of the average of the absolute value of the gain-compensated Q-digital signal to the average of the absolute value of the feedback Q-digital signal is detected as the second gain correction signal (β) (step S75), and then the first and second gain correction signals (α and β) are respectively multiplied by the feedback I/Q digital signals, thereby compensating a gain imbalance (step S76).

In order to compensate a phase imbalance of the I/Q digital signals, a time delay between the reference I-digital signal (Vref_I) and the feedback I-digital signal (Vfb_I) should be compensated.

The time delay is compensated using a principle that, assuming that the reference I-digital signal (Vref_I) and the feedback I-digital signal (Vfb_I) are the same signals and there exists a time delay, if a difference between two signals is ‘0’, they are the same signals without a time delay.

However, actually, since the feedback I-digital signal (Vfb_I) contains an error component, it is determined that a time delay is compensated when the difference between the reference I-digital signal (Vref_I) and the feedback I-digital signal (Vfb_I) is minimal.

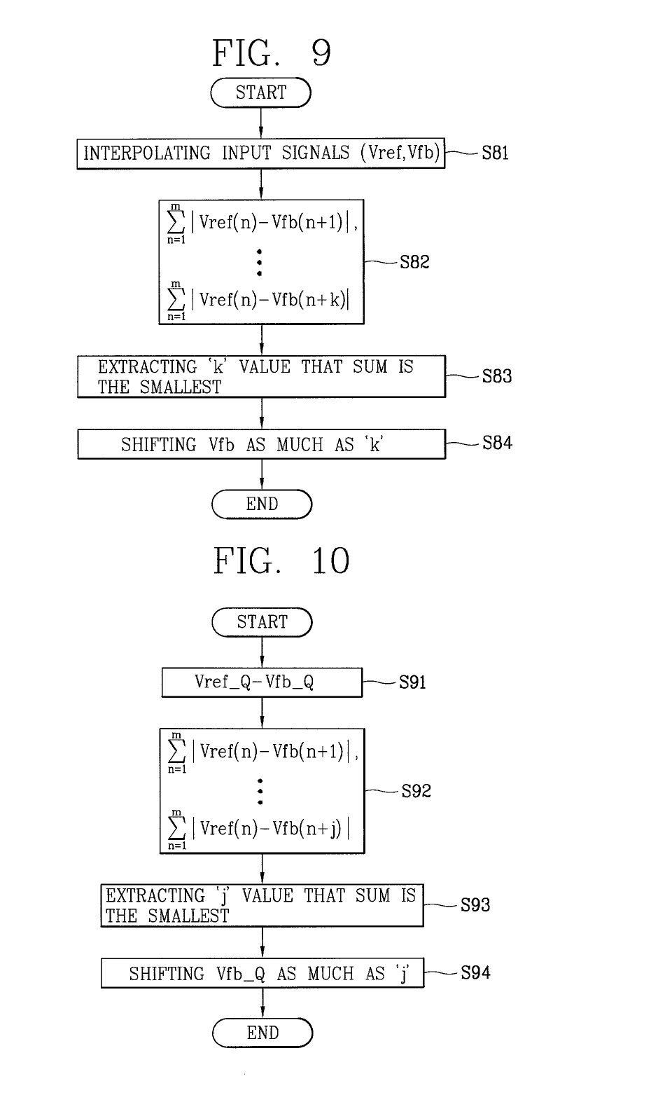

Referring to FIG. 9, the reference I-digital signal (Vref_I) and the feedback I-digital signal (Vfb_I) are interpolated at an arbitrary over sampling rate (OSR) (step S81), each interpolated reference I-digital signal and the feedback I-digital signal are subtracted, and the subtracted values are added (step S82).

At this time, in an ideal case where sizes of the two signals are identical to each other and there is no time difference, the subtracted value becomes ‘0’, while if there is a time delay, the subtracted value has a value corresponding to the time delay.

The operation of obtaining the sum of the difference value between the reference I-digital signal and the feedback I-digital signal while increasing ‘k’, the constant of the over sampling rate one by one, that can be expressed by equation (2):

$${\sum }_{n = 1}^{m} \vert {V}_{ref} ( n ) - {V}_{fb} ( n + 1 ) \vert , {\sum }_{n = 1}^{m} \vert {V}_{ref} ( n ) - \\ {V}_{fb} ( n + 2 ) \vert , … , {\sum }_{n = 1}^{m} \vert {V}_{ref} ( n ) - {V}_{fb} ( n + k ) \vert \qquad ( 2 )$$

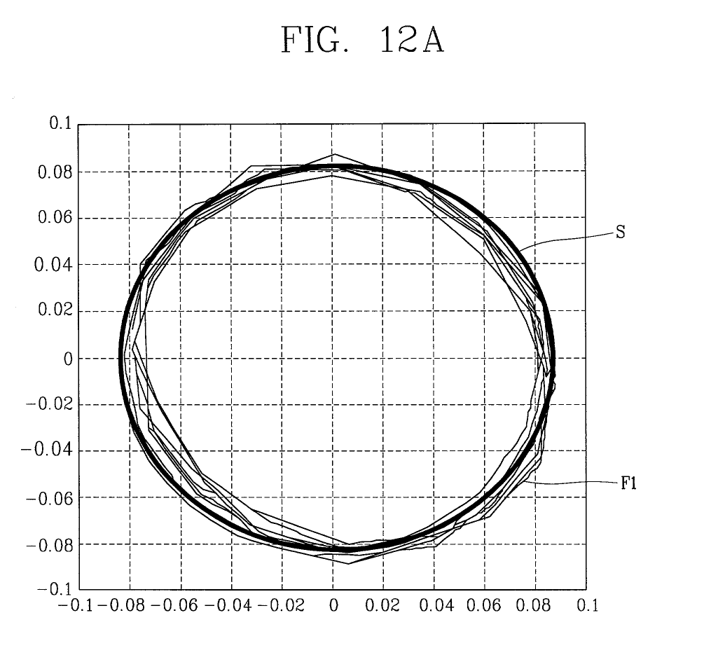

FIGS. 11A through 11C are waveforms showing change in relation between the reference I-digital signal and the feedback I-digital signal according to increase in the value ‘k’, the constant of the over sampling rate.

At this time, it is noted that, as the value ‘k’ is increased, the sums of the difference between the two signals are gradually diminished.

Namely, when the sums of the difference, that is, an output value, is minimized by changing the value ‘k’ (step S83), a time delay between the two signals is the minimum.

Accordingly, the two signals can ideally compared by shifting the feedback I/Q digital signals as much as the value ‘k’ calculated as described above (step S84).

The time delay value can be expressed by equation (3):

$$\frac{1}{TimeDelay} = \frac{SamplingRate}{OverSamplingRate} \times k \\ ∴ TimeDelay \frac{OverSamplingRate}{SamplingRate \times k} \qquad ( 3 )$$

Thereafter, a phase correction constant (j) is obtained by using the time delay-compensated Q-digital signal (Vfb_Q) and the reference Q-digital signal (Vref_Q), the feedback Q-digital signal (Vfb_Q) is shifted as much as the phase correction constant (j).

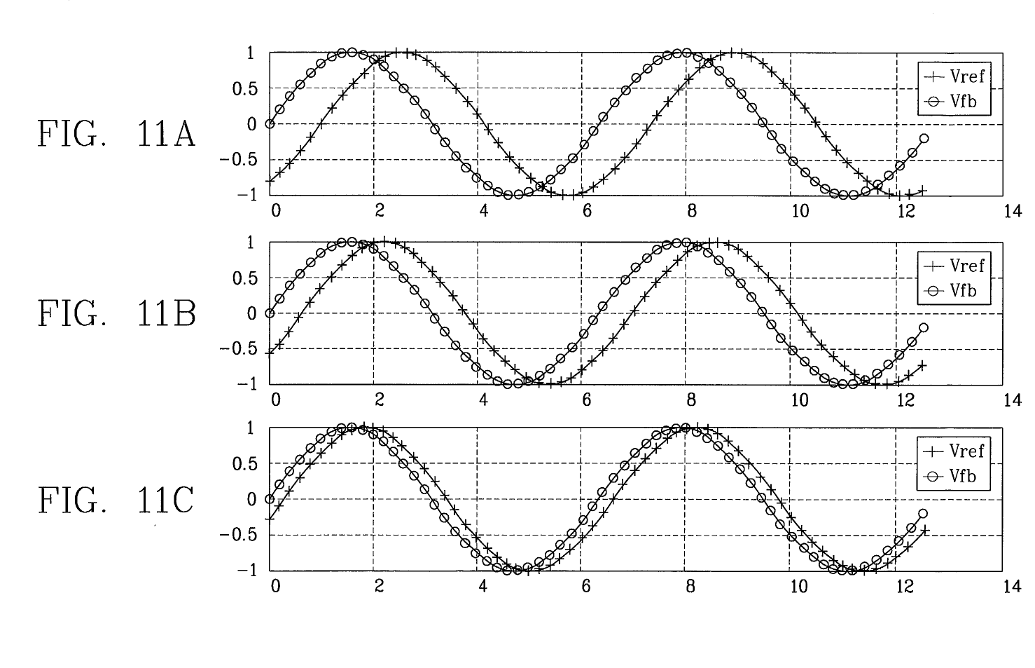

That is, as shown in FIG. 10, the feedback Q-digital signal (Vfb_Q) is subtracted from the reference Q-digital signal (Vref_Q) (step S91), the sums of the subtracted values are obtained (step S92), and then, the smallest value of the sums is extracted as a phase correction constant (step S93). The feedback Q-digital signal (Vfb_Q) is shifted as much as the phase correction constant (j), thereby compensating the phase between the two signals (step S94).

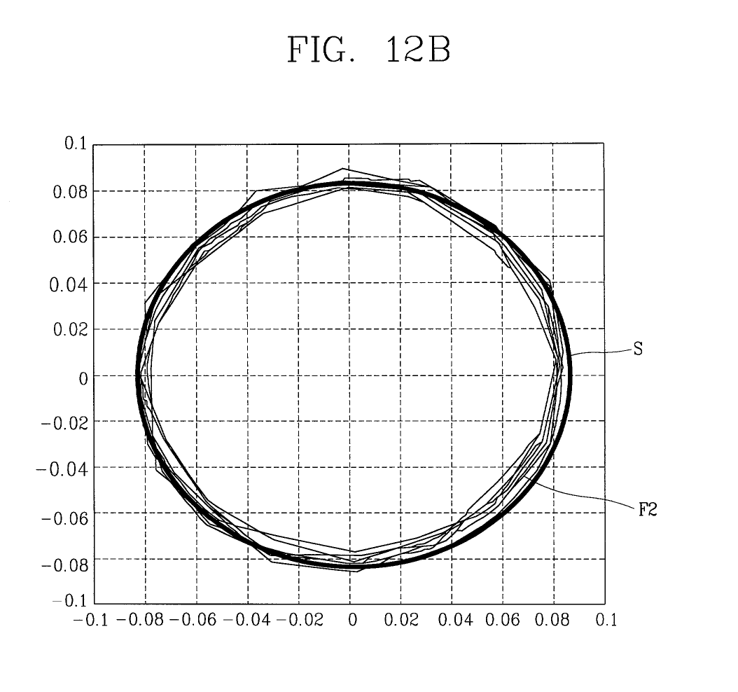

FIGS. 12A and 12B show reference I/Q digital signals before and after AQM error compensation.

As shown in FIG. 12A, the feedback I/Q digital signals (F1) has an inclined circular form compared with the reference I/Q digital signal (S) with the ideal circle form, but the AQM error-compensated I/Q digital signals (F2) are shown to be corrected to a circular form almost corresponding to the reference I/Q digital signals (S) as shown in FIG. 12B.

As so far described, the AQM error compensating apparatus and method of the present invention has many advantages.

For example, first, the AQM error can be compensated by extracting the DC offset and gain and the correction value for the phase error by using a sine wave for an initial certain time of a system, and even while a signal is being transmitted after being varied, the AQM error also can be compensated by comparing an inputted reference signal and a feedback signal and extracting a correction value for each error. Thus, the error can be accurately compensated according to its occurrence.

Secondly, the feedback digital signal used for measuring the AQM error is extracted in a digital method to remove a calculation error of the AQM error due to the nonlinear characteristics, so that the error due to the operation area and the nonlinear characteristics generated in compensating the AQM error can be reduced.

Lastly, the time delay can be compensated without using a delay device, so that a unit cost of a product can be reduced and a reproductibility of a signal can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An AQM error compensating apparatus wherein an error correction signal for compensating an error is outputted by using a reference signal inputted to a predistorter and a feedback signal inputted from a direction coupler through a main path.

2. The apparatus of claim 1, wherein the error correction signal comprises:
first and second DC offset signals for correcting a DC offset of I/Q digital signals;
first and second gain correction signals for compensating a gain of I/Q digital signals; and
a phase correction signal for compensating a phase of I/Q digital signal.

3. An AQM error compensating apparatus comprising:
a predistorter for distorting a signal so as to have the opposite characteristics of nonlinear distortion characteristics of a digital input signal;
an error compensating unit for compensating I/Q digital signals outputted from the predistorter according to an error correction signal;
a digital/analog converter for converting the I/Q digital signals of the error compensating unit into I/Q analog signals;
a modulator for frequency-modulating the I/Q analog signals outputted from the digital/analog converter;
a power amplifier for amplifying the output signal of the modulator to a directional coupler;
a down-converter for down-converting a feedback signal inputted from the directional coupler;
an analog/digital converter for converting the output signal of the down-converter into a digital signal; and
a controller for comparing the output signal of the analog/digital converter with the I/Q digital signals inputted from the predistorter, and applying an extracted error correction signal into the error compensating unit.

4. The apparatus of claim 3, wherein the error correction signal comprises:
first and second DC offset signals for correcting a DC offset of I/Q digital signals;
first and second gain correction signals for compensating a gain of I/Q digital signals; and
a phase correction signal for compensating a phase of I/Q digital signal.

5. The apparatus of claim 3, wherein a signal for controlling the predistorter and a reference signal for calculating an AQM error are exchanged between the controller and the predistorter.

6. An AQM error compensating method comprising a step for in which an error is compensated after outputting an error correction signal by using a reference signal inputted to a predistorter and a feedback signal inputted from a directional coupler through a main path.

7. The method of claim 6, wherein the error correction signal comprises:
first and second DC offset signals for correcting a DC offset of I/Q digital signals;
first and second gain correction signals for compensating a gain of I/Q digital signals; and
a phase correction signal for compensating a phase of I/Q digital signal.

8. The method of claim 6, wherein the error compensating step comprises:
removing a DC offset of feedback I/Q digital signals;
compensating a gain of the I/Q digital signals with no DC offset; and
compensating a phase of the gain-compensated I/Q digital signals;

9. The method of claim 8, further comprising: compensating a time delay of the feedback I/Q digital signals.

10. The method of claim 8, wherein the step of removing a DC offset comprises:
extracting each average value of the feedback I/Q digital signals;
subtracting each average value from the feedback I/Q digital signals; and
determining the obtained difference value as first and second DC offset signals.

11. The method of claim 8, wherein the gain compensating step comprises:
extracting absolute values of the reference I/Q digital signal inputted from the predistorter and the feedback I/Q digital signals;
extracting an average value for each absolute value of the above step;
extracting a ratio of an average value of the absolute values of the reference I/Q digital signals for the absolute values of the feedback I/Q digital signals; and
multiplying the I/Q digital signals by the extracted ratio of the average value to accordingly detect first and second gain correction signals.

12. The method of claim 8, wherein the phase compensating step comprises:
subtracting the feedback Q-digital signal from a reference Q-digital signal;
adding the subtracted values to obtain each sum and extracting the smallest sum value as a phase correction constant; and
shifting the feedback Q-digital signal according to the phase correction signal adopting a phase correction constant.

13. The method of claim 9, wherein the time delay compensating step comprises:
interpolating reference I/Q digital signals and feedback I/Q digital signals;
subtracting the feedback I-digital signal from the reference I-digital signal;
adding the subtracted values to obtain each sum and extracting the smallest sum value as a delay constant; and
shifting the feedback I/Q digital signals according to a time correction signal adopting a delay constant.

14. An AQM error compensating method comprising:
removing a DC offset of feedback I/Q digital signals;
compensating a gain of the DC offset-removed I/Q digital signals;
compensating a time delay of the gain-compensated I/Q digital signals; and
compensating a phase of the time delay-compensated I/Q digital signals.

15. The method of claim 14, wherein the DC offset removing step comprises:
extracting each average value of the feedback I/Q digital signals;
subtracting each average value from the feedback I/Q digital signals; and
determining the obtained difference value as first and second DC offset signals.

16. The method of claim 14, wherein the gain compensating step comprises:
extracting an absolute value of the reference I/Q digital signal inputted from the predistorter and the feedback I/Q digital signals;
extracting an average value for each absolute value of the above step;
extracting an average value ratio of the absolute value of the reference I//Q digital signals for the absolute value of the feedback I/Q digital signals; and
multiplying the I/Q digital signals by the extracted ratio of the average value to accordingly detect first and second gain correction signals.

17. The method of claim 14, wherein the time delay compensating step comprises:
interpolating reference I/Q digital signals and feedback I/Q digital signals;
subtracting the feedback I-digital signal from the reference I-digital signal;
adding the subtracted values to obtain each sum and extracting the smallest sum value as a delay constant; and
shifting the feedback I/Q digital signals according to a time correction signal adopting a delay constant.

18. The method of claim 14, wherein the phase compensating step comprises:
subtracting the feedback Q-digital signal from a reference Q-digital signal;
adding the subtracted values to obtain each sum and extracting the smallest sum value as a phase correction constant; and
shifting the feedback Q-digital signal according to the phase correction signal adopting a phase correction constant.

19. An AQM error compensating method comprising the steps of:
interpolating I/Q digital signals inputted from a predistorter and feedback I/Q digital signals;
compensating a gain by corresponding the sizes of two interpolated signals;
repeatedly performing an operation that a time difference between the two size-corresponded signals is calculated while varying a constant value for an over-sampling ratio; and
calculating a constant value that a time difference is minimal.

20. The method of claim 19, wherein the signal size corresponding step comprises:
obtaining sizes of the two signals;
dividing a size average value of the reference I/Q digital signals by a size average value of the feedback signals, in order to obtain a size ratio; and
multiplying the feedback I/Q digital signals by the size ratio.
